(19) United States
(12) Patent Application Publication
(10) Pub. No.: US 2019/0269152 A1
(43) Pub. Date: Sep. 5, 2019

(54) Compositions and Methods of Pet Food

(71) Applicants: Hill's Pet Nutrition, Inc., Topeka, KS (US); DSM IP Assets B.V., Heerlen (NL)

(72) Inventors: Kiran PANICKAR, Lawrence, KS (US); Dennis JEWELL, Lawrence, KS (US); Regina GORALCZYK, Basel (CH); Jenny PIUSSI, Basel (CH); Hasan MOHAJERI, Basel (CH)

(73) Assignees: Hill's Pet Nutrition, Inc., Topeka, KS (US); DSM IP Assets B.V., Heerlen (NL)

(21) Appl. No.: 16/348,879

(22) PCT Filed: Nov. 10, 2017
(86) PCT No.: PCT/US2017/060983

§ 371 Date: May 10, 2019

Related U.S. Application Data
(60) Provisional application No. 62/421,006, filed on Nov. 11, 2016.

(51) Int. Cl. A23K 20/111; A23K 10/30; A23K 20/105; A23K 20/121; A23K 20/163; A23K 20/174; A23K 20/137; A23K 50/42; A23K 50/48

(52) U.S. Cl. CPC A23K 20/111; A23K 10/30; A23K 20/105; A23K 20/121; A23K 50/48; A23K 20/174; A23K 20/137; A23K 50/42; A23K 20/163

(57) ABSTRACT

Disclosed herein are pet food compositions comprising steviol. Methods of making and using the compositions are also provided.

### FIELD

This disclosure relates to pet food compositions comprising steviol as well as to methods of using and of making these compositions.

### BACKGROUND

In recent decades, there has been increased interest in developing natural non-caloric sweeteners, providing sensory properties similar to sucrose. One of the most promising alternatives is the steviol glycosides, high-sweetness compounds extracted from the leaves of Stevia rebaudiana Bertoni (Gonzalez et al., Fruits, 2014, 69(2): 127-141). Due to their unique ability in not inducing a glycemic response, these glycosides have been used as sugar substitutes that can be used by diabetics. Steviol glycosides (see FIG. 1B) are the main ingredients (or precursors) of many sweeteners marketed under the generic name stevia and several trade names.

Steviol (see FIG. 1A) is a diterpene first isolated from Stevia rebaudiana, a perennial herb known for its sweet leaves. It is an aglycone of stevia's glycosides. Steviol occurs naturally in Stevia rebaudiana in the form of steviol glycosides. While these glycosides are responsible for the sweet taste attributed to the plant, steviol does not have a sweet taste and is considered tasteless. Steviol may also be formed within the gastrointestinal tract of animals by the hydrolysis of stevioside and rebaudioside A, major glycosides found in stevia plant, after oral intake, which is then absorbed into the circulatory system. Steviol has been shown to have anti-inflammatory effects on colonic epithelial cells (Boonkaewwan & Burodom, J Sci Food Agric., 2013 December; 93(15):3820-5), hepatoprotective effects (Holvoet et al., Food Chem Toxicol. 2015 March; 77:22-33) and anti-carcinogenic effects (Yasukawa et al., Biol Pharm Bull., 2002 November; 25(11): 1488-90). Steviol has been described as useful to enhance the overall appearance of an animal's hair, fur, feathers or scales (WO2011009863, filed Jul. 20, 2010).

Current pet food products do not adequately offer palatability enhancing properties. Such properties are useful, for example, to increase food intake in aging dogs which may generally suffer from decreased food intake. Accordingly, there is a need for pet food compositions to offer palatability enhancing properties.

### BRIEF SUMMARY

It has been surprisingly found that pet food compositions comprising steviol possess palatability enhancing effects. Such pet food compositions show an unexpected increase in palatability and subsequent food intake.

In one embodiment, the pet food composition includes steviol. In a further embodiment, the steviol may be present in an amount of 0.003 to 0.011% by weight of the pet food composition. In a further embodiment, the steviol may be present in an amount of 0.005 to 0.009% by weight of the pet food composition. In certain embodiments, the steviol may be present in an amount of 0.007% by weight of the pet food composition.

In a particular embodiment, a method to improve food intake of a pet may be provided. The method may include providing an effective amount of the pet food composition of any of the compositions described herein to a pet. In certain embodiments, the pet may be a canine or feline. In certain embodiments, the method may use a solid or liquid pet food composition.

In further embodiments, methods of manufacturing a pet food composition comprising steviol may be provided. In certain embodiments, the steviol in the manufactured pet food composition may be present in an amount of 0.003 to 0.011% by weight of the pet food composition. In certain embodiments, the steviol in the manufactured pet food composition may be present in an amount of 0.005 to 0.009% by weight of the pet food composition. In certain embodiments, the steviol in the manufactured pet food composition may be present in an amount of 0.007% by weight of the pet food composition.

In certain embodiments, a pet food composition obtained or obtainable by combining the ingredients as set forth in any of the preceding compositions and methods may be provided.

### BRIEF DESCRIPTION OF THE DRAWINGS

The accompanying drawings, which are incorporated in and constitute a part of this specification, illustrate the present teachings and together with the description, serve to explain the principles of the disclosure.

FIG. 1A is the molecular structure of steviol.

FIG. 1B is the molecular structure for steviol glycoside.

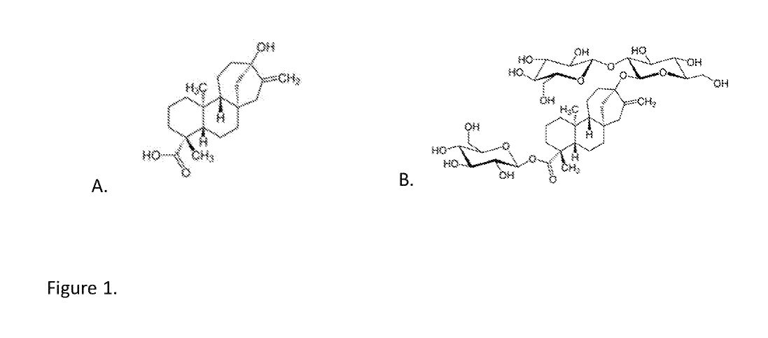

### DETAILED DESCRIPTION

The following description of embodiment(s) of the disclosure is merely exemplary in nature and is in no way intended to limit the disclosure, its application, or uses.

As used herein, the words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

As used herein, the term “food” may refer not only to a food product which typically provides most, if not all, the nutrient value for a companion animal, but may also refer to such items as a snack, treat, supplement, and the like.

As used throughout, ranges are used as shorthand for describing each and every value that is within the range. Any value within the range can be selected as the terminus of the range.

Unless stated otherwise, all percentages of composition components given in this specification are by weight based on a total composition or formulation weight of 100%.

All references cited herein are hereby incorporated by reference in their entireties. In the event of a conflict in a definition in the present disclosure and that of a cited reference, the present disclosure controls.

The term “effective amount” as used herein means that the amount of the composition is of sufficient quantity to achieve the intended purpose, such as, for example, to induce or cause increased food intake in the subject. Such effective activity may be achieved, for example, by administration of compositions of the present disclosure to an animal. An effective amount may be based on several factors, including an animal's ideal weight, the metabolizable energy of the composition, and frequency of feeding the animal one or more compositions of the present disclosure, e.g., once, twice, or three times daily, and other compositions fed to the animal.

The compositions and formulations as provided herein are described and claimed with reference to their ingredients, as is usual in the art. As would be evident to one skilled in the art, the ingredients may in some instances react with one another, so that the true composition of the final formulation may not correspond exactly to the ingredients listed. Thus, it should be understood that the pet food compositions disclosed herein may extend to the product of the combination of the listed ingredients.

In at least one implementation, food compositions comprising steviol are provided. In certain preferred embodiments, pet food compositions comprising steviol are provided. Such compositions provide unique features, such as enhanced palatability characteristics, useful in food compositions, particularly pet food compositions.

In some embodiments, steviol may be present in an amount of 0.0007 to 0.07% by weight of the pet food composition. In a further embodiment, the steviol may be present in an amount of 0.001 to 0.05% by weight of the pet food composition. In a further embodiment, the steviol may be present in an amount of 0.003 to 0.011% by weight of the pet food composition. In a further embodiment, the steviol may be present in an amount of 0.005 to 0.009% by weight of the pet food composition. In further embodiments, steviol may be present in an amount 0.007 to 0.01% by weight of the pet food composition. In certain embodiments, the steviol may be 0.007% by weight of the pet food composition.

In a particular embodiment, methods to improve food intake of a pet may be provided. The method may include providing an effective amount of the pet food composition of any of the compositions described herein to the oral cavity of a pet in need thereof. In a particular embodiment, a method to improve food intake of a pet is provided. The method may include providing an effective amount of the pet food composition described herein to a pet. In certain embodiments, the pet food composition may be a solid pet food composition or a liquid pet food composition. In certain embodiments, the pet may be a canine or feline. In further compositions, methods of manufacturing a pet food comprising steviol may be provided.

A “nutritionally complete diet” may be a diet that includes sufficient nutrients for maintenance of normal health of a healthy animal on the diet. Nutritionally complete and balanced pet food compositions are familiar to one of skill in the art.

For example, a nutritionally complete and balanced dog food composition may comprise: about 0 to about 90%, preferably about 5% to 60%, by weight of carbohydrates; about 5% to about 70%, preferably about 10% to about 60%, more preferably about 200 to about 50%, by weight of protein; about 1% to about 50%, preferably about 2% to about 40%, more preferably about 3% to about 15%, by weight of fat; about 0.1% to about 40%, preferably about 1% to about 30%, more preferably about 15% to about 50%, by weight of total dietary fiber; about 0 to about 15%, preferably about 2% to about 8%, by weight of vitamins and minerals, antioxidants, and other nutrients which support the nutritional needs of the animal.

Protein may be supplied by any of a variety of sources known by those skilled in the art, including plant sources, animal sources, or both. Animal sources may include, for example, meat, meat by-products, seafood, dairy, eggs, etc. Meats may include, for example, the flesh of poultry, fish, and mammals (e.g., cattle, pigs, sheep, goats, and the like). Meat by-products may include, for example, lungs, kidneys, brain, livers, and stomachs and intestines (freed of all or essentially all their contents). The protein may be intact, almost completely hydrolyzed, or partially hydrolyzed. The amount of “crude protein” in a composition disclosed herein may be determined based on the amount of nitrogen in the composition according to methods familiar to one of skill in the art. As contemplated herein, the compositions may comprise from about 5% to about 70% protein, from about 10% to about 60% protein, from about 20% to about 50% protein, from about 25% to about 40% protein, and from about 29% to about 38% protein.

In certain embodiments, the nutritionally complete pet food compositions disclosed herein may comprise fat. Sources of fat for the compositions may be supplied by any of a variety of sources known by those skilled in the art, including meat, meat by-products, fish oil, and plants. Plant fat sources may include wheat, flaxseed, rye, barley, rice, sorghum, corn, oats, millet, wheat germ, corn germ, soybeans, peanuts, and cottonseed, as well as oils derived from these and other plant fat sources. As contemplated herein, the compositions may comprise from about 1% to about 20%, fat, from about 2% to about 18% fat, from about 3% to about 15% fat, from about 7% to about 14% fat, and from about 9% to about 12% fat.

The compositions may further contain additives known in the art. Preferably, such additives are present in amounts that do not impair the purpose and effect provided by the pet food compositions disclosed herein. Examples of contemplated additives include, for example, substances that are functionally beneficial to weight management, substances with a stabilizing effect, processing aids, substances that enhance palatability, coloring substances, and substances that provide nutritional benefits.

Contemplated substances that may provide a benefit for weight management include, for example, non-fermentable fiber, carnitine, chromium-picolinate, and the like.

Contemplated stabilizing substances include, for example, substances that tend to increase the shelf life of the composition. Potentially suitable examples of such substances include, for example, preservatives, antioxidants, synergists and sequestrants, packaging gases, stabilizers, emulsifiers, thickeners, gelling agents, and humectants. Examples of emulsifiers and/or thickening agents may include, for example, gelatin, cellulose ethers, starch, starch esters, starch ethers, and modified starches.

Contemplated additives for coloring, palatability, and nutritional purposes include, for example, colorants; iron oxide, sodium chloride, potassium citrate, potassium chloride, and other edible salts; vitamins; minerals; and flavoring. The amount of such additives in a composition typically may be up to 5% (dry basis of the composition).

Supplements include, for example, a feed used with another feed to improve the nutritive balance or performance of the total. Contemplated supplements include compositions that are fed undiluted as a supplement to other feeds, offered free choice with other parts of an animal's ration that are separately available, or diluted and mixed with an animal's regular feed to produce a complete feed. The Association of American Feed Control Officials (AAFCO), for example, provides a discussion relating to supplements in the American Feed Control Officials, Inc. Official Publication, p. 220 (2003). Supplements may be in various forms including, for example, powders, liquids, syrups, pills, etc.

In preparing a composition disclosed herein, the components of the composition may be adjusted so that steviol is present in the composition at a final concentration of from 0.0007% up to 25% (or from 0.0007% to 20%, or from 0.0007% to 0.07%, or from 0.003% to 1%) based on the dry content of the composition. The steviol may, for example, be incorporated into the composition during the processing of the formulation, such as during and/or after mixing of other components of the composition. Distribution of these components into the composition can be accomplished by conventional means.

Methods to improve food intake of a pet are disclosed. The methods may include applying or feeding an effective amount of the pet food composition comprising steviol to a pet or the oral cavity of a pet in need thereof. In certain embodiments, the methods to improve food intake of a pet include applying or feeding an effective amount of the pet food composition comprising steviol to a pet or the oral cavity of a pet in need thereof, wherein the effective amount is 0.0007 to 0.07% steviol. In certain embodiments, the methods to improve food intake of a pet include applying an effective amount of the pet food composition comprising steviol to the oral cavity of a pet in need thereof, wherein the pet is a canine or feline. In certain embodiments, the methods to improve food intake of a pet includes applying an effective amount of the pet food composition comprising steviol to the oral cavity of a pet in need thereof, wherein the pet food composition is a solid or liquid.

Methods for encouraging a pet to ingest food are disclosed. For example, methods disclosed may include methods for encouraging a pet that is reluctant to ingest food and/or exhibits reduced appetite (e.g., due to sickness or treatment of a sickness). The method may include administering or feeding the pet in need thereof a pet food composition including an effective amount of steviol to encourage the pet to ingest the pet food composition. In at least one implementation, the pet in need thereof may be an elderly pet. For example, the pet may be reluctant to eat and/or exhibit reduced appetite due to age.

In at least one implementation, a pet in need thereof may include any pet in which an increase or relative increase in pet food consumption is therapeutically beneficial. Illustrative examples of pets in need thereof may include, but are not limited to, pets having digestive problems (e.g., IBD), stressed pets, recovering or convalescing pets, pets in need of increased caloric intake/content, lactating pets, nursing pets, pregnant pets, pets suffering from kidney disease, senior or geriatric pets, pets with cancer or other underweight pets. In at least one implementation, the pet may not need fur or hair improvement.

Methods for marketing a pet food composition including steviol may also be provided. The method may include preparing the pet food composition according to any one or more of the methods disclosed herein, and providing information or informational material to a potential buyer or consumer. The potential buyer or consumer may be an owner, caretaker, or veterinarian of a pet in need of encouragement to ingest food or in need of increasing food consumption. The information or informational material provided to the potential buyer or consumer may inform the buyer or consumer of the ability or efficacy of the pet food composition to encourage a pet in need thereof to ingest the pet food composition. The information or informational material provided to the potential buyer or consumer may also inform the buyer or consumer that the pet food composition disclosed herein exhibits relatively greater palatability than pet food compositions without steviol.

The informational material may be part of the material used to package the pet food composition. For example, the informational material may be printed on a label affixed to the outside of a container (e.g., jar, pouch, bag, sac, can, etc.) capable of containing or packaging the pet food composition. Alternatively and/or additionally, the informational material may be on a separate insert placed in the container. The informational material may be provided to the buyer or consumer through conventional marketing methods using a variety of media, such as through mass communication advertising (e.g., TV, radio, print, internet, social networking, etc.). It should be appreciated that the exact form of the informational material is not critical so long as the information provided informs the potential buyer or consumer of the benefits of the pet food compositions disclosed herein that include steviol.

Methods for manufacturing a pet food comprising steviol are provided. In certain embodiments, the pet food may be in solid or liquid form. In certain embodiments, the pet food may be in dry or wet form.

Compositions disclosed herein may be prepared in a canned or wet form using conventional pet food processes. In one contemplated embodiment, ground animal and poultry proteinaceous tissues may be mixed with the other ingredients, including fish oils, cereal grains, other nutritionally balancing ingredients, special purpose additives (e.g., vitamin and mineral mixtures, inorganic salts, cellulose and beet pulp, bulking agents, and the like); and water sufficient for processing may also be added. These ingredients preferably may be mixed in a vessel suitable for heating while blending the components. Heating of the mixture may be effected using any suitable manner, such as, for example, by direct steam injection or by using a vessel fitted with a heat exchanger. Following the addition of the last ingredient, the mixture may be heated to a temperature range of from about 50° F. to about 212° F. Temperatures outside this range are acceptable, but may be commercially impractical without the use of other processing aids. When heated to the appropriate temperature, the material will typically be in the form of a thick liquid. The thick liquid may be filled into cans. A lid may be applied, and the container may be hermetically sealed. The sealed can may then be placed into conventional equipment designed to sterilize the contents. This is usually accomplished by heating to temperatures of greater than about 230° F. for an appropriate time, which is dependent on, for example, the temperature used and the composition.

Compositions disclosed herein may be prepared in a dry form using conventional processes. In one contemplated embodiment, dry ingredients, including, for example, animal protein sources, plant protein sources, grains, etc., may be ground and mixed together. Moist or liquid ingredients, including fats, oils, animal protein sources, water, etc., may then be added and mixed with the dry mix (which, in a contemplated embodiment, comprises at least 0.003% of the desired steviol amount for the final product). The mixture may then be processed into kibbles or similar dry pieces. Kibble may often be formed using an extrusion process in which the mixture of dry and wet ingredients is subjected to mechanical work at a high pressure and temperature, and forced through small openings and cut off into kibble by a rotating knife. The wet kibble may then be dried and optionally coated with one or more topical coatings which may include, for example, flavors, fats, oils, powders, and the like. Kibble also may be made from the dough using a baking process, rather than extrusion, wherein the dough is placed into a mold before dry-heat processing.

The following examples further describe and demonstrate embodiments within the scope of the present disclosure. These examples are given solely for the purpose of illustration and are not to be construed as limitations of the present disclosure as many variations thereof are possible without departing from the scope.

### Example 1—Animal Preference Testing of Food Containing Steviol

A two-choice preference test was conducted with 25 adult beagles on 2 subsequent days. All dogs had two bowls, each having 500 grams of food, presented to them on both days with one bowl containing a control diet (brewers rice, dried egg product, natural flavor, pork fat, soybean oil, lactic acid, powdered cellulose, dicalcium phosphate, fish oil, potassium chloride, vitamins, calcium carbonate, choline chloride, iodized salt, taurine, minerals, tocopherols, citric acid, phosphoric acid, beta-carotene and rosemary extract) and another containing the test diet (control diet+0.007% by weight of steviol (Cat. # Stevio8373, DSM Nutritional Products, Heerlen, Netherlands)). Access to the food was made for 30 minutes. At the end of 30 minutes, the food amount in both bowls was measured. The total consumption out of the two respective bowls was quantified to determine whether one bowl or the other was consumed in a greater proportion. Thus, the possible results are preference for control diet, test diet, or neither. The average number of dogs from both days that preferred the test diet was 22.5 whereas only 2.5 preferred the control diet (p<0.05). In addition, the average intake of the test diet was 136.82 g whereas for the control diet it was 53.26 g (p<0.05).

TABLE 1
Testing Summary

| Description | Day 1-Feeding | Day 2-Feeding | Average |
|---|---|---|---|
| Number of | 25 | 25 | 25 |
| observations | | | |
| Number preferring | 23 | 22 | 22.5 |
| Test diet | | | |
| Number preferring | 2 | 3 | 2.5 |
| Control diet | | | |
| Number with no | 0 | 0 | 0 |
| preference | | | |
| Percent preferring | 92 | 88 | 90 |
| Test diet | | | |
| Percent preferring | 8 | 12 | 10 |
| Control diet | | | |
| Ave. total Intake | 189.6 | 190.56 | 190.08 |
| Ave. intake of Test | 140.8 | 132.84 | 136.82 |
| diet | | | |
| Ave. intake of | 48.8 | 57.72 | 53.26 |
| control diet | | | |
| Intake ratio | 0.745 | 0.711 | 0.728 |
| Standard error | 0.0414 | 0.0475 | 0.04445 |

### Example 2—Animal Preference Testing of Food Containing Botanicals

This study was conducted to assess whether addition of health-benefiting botanicals to a canine diet would affect the palatability.

Botanical ingredients are known to lower palatability. The two botanical ingredients that were used in the diet were cinnamon extract and green tea extract. Bioactives hypothesized to have an effect in cinnamon are proanthocyanidins, which are polyphenolic flavonoids. Many of these proanthocyanidins are dimers, trimers or oligomers of catechins and epicatechins, which are also polyphenols. Proanthocyanidins are generally known to impart a bitter and astringent taste (Gonzalo-Diago et al., J Agric Food Chem., 2013, 61(37), 8861-70).

The green tea extract is also rich in polyphenols. The primary bioactive polyphenols in green tea extract are epigallocatechin gallate (EGCG), epicatechin gallate (ECG) and epicatechins. Catechins, in general, have been reported to have a bitterness taste (Narukawa et al., Int J Food Sci Tech, 2010, 45, 1579-1585; Narukawa et al., Biochem Biophys Res Commun., 2011, 405(4), 620-5).

The testing protocol was conducted similarly as described for Example 1, with the exception that the control diet here was comprised of brewers rice, chicken meal, whole grain sorghum, cracked pearled barley, pea protein, egg product, soybean oil, flaxseed, chicken liver flavor, whole grain oats, dried beet pulp, fish oil, pork liver flavor, lactic acid, chicken fat, potassium chloride, lipoic acid, choline chloride, iodized salt, vitamins, calcium carbonate, green peas, apples, cranberries, carrots, minerals, taurine, natural flavors, mixed tocopherols, broccoli and beta-carotene. The test diet comprised the control diet with botanicals added (botanicals were made from green tea (Sabinsa Corp., East Windsor, N.J.) and cinnamon (IN Ingredients, Columbia, Tenn.), each had a final 0.25% concentration). An average of 16 of the dogs (65.4%) preferred the control diet but only 8.5 dogs (34.6%) preferred the test diet with added botanicals. One dog showed no preference. The average intake of the control diet was 109.425 grams compared to 81.995 grams for the test diet.

TABLE 2
Testing Summary

| Description | Day 1-Feeding | Day 2-Feeding | Average |
|---|---|---|---|
| Number of | 24 | 25 | 24.5 |
| observations | | | |
| Number preferring | 17 | 15 | 16 |
| Control diet | | | |
| Number preferring | 7 | 10 | 8.5 |
| Test diet | | | |
| Number with no | 0 | 0 | 0 |
| preference | | | |
| Percent preferring | 70.8 | 60 | 65.4 |
| Control diet | | | |
| Percent preferring | 29.2 | 40 | 34.6 |
| Test diet | | | |
| Number with | 1 | 0 | 0.5 |
| Invalid Data | | | |
| Ave. total intake | 189.92 | 192.92 | 191.42 |
| Ave. intake of | 104.17 | 114.68 | 109.425 |
| control diet | | | |
| Ave. intake of Test | 85.75 | 78.24 | 81.995 |
| diet | | | |
| Intake ratio | 0.54 | 0.562 | 0.551 |
| Standard error | 0.0362 | 0.043 | 0.0396 |

### Example 3—Animal Preference Testing of Food Containing Steviol or Botanicals

This study was conducted as described for Example 1, with the exception that a diet containing Steviol was compared with a diet containing botanicals.

The control diet used here was the same formulation as the control diet in Example 2 with the addition of 0.007% Steviol. The test diet used was the same formulation as the test diet from Example 2, which contained botanicals. An average of 20.5 of the 25 dogs preferred the control diet with steviol when compared to 3.5 of the 25 dogs preferring the test diet (P<0.05). The average intake of the control diet was 116.76 g when compared to 64.74 g for the test diet.

TABLE 3
Testing Summary

| Description | Day 1-Feeding | Day 2-Feeding | Average |
|---|---|---|---|
| Number of | 25 | 25 | 25 |
| observations | | | |
| Number preferring | 19 | 22 | 20.5 |
| Control diet | | | |
| Number preferring | 4 | 3 | 3.5 |
| Test diet | | | |
| Number with no | 2 | 0 | 1 |
| preference | | | |
| Percent preferring | 76 | 88 | 82 |
| Control diet | | | |
| Percent preferring | 16 | 12 | 14 |
| Test diet | | | |
| Ave. total intake | 183.32 | 179.68 | 181.5 |
| Ave. intake of | 113.64 | 119.88 | 116.76 |
| control diet | | | |
| Ave. intake of Test | 69.68 | 59.8 | 64.74 |
| diet | | | |
| Intake ratio | 0.382 | 0.333 | 0.3575 |
| Standard error | 0.0431 | 0.0454 | 0.04425 |

### Example 4—Animal Preference Testing of Food Containing Steviol and Botanicals

This study was conducted as described for Example 1. The control diet used here was the same formulation as the control diet in Example 2. The test diet comprised the control diet formulation with botanicals (see Example 2) and 0.007% steviol added. An average of 10 dogs out of 25 (40%) preferred the control diet whereas 15 of 25 dogs (60%, p<0.05) preferred the test diet with steviol and botanicals. Our results indicate an important role for steviol as a palatability enhancer for canine food.

TABLE 4
Testing Summary

| Description | Day 1-Feeding | Day 2-Feeding | Average |
|---|---|---|---|
| Number of | 25 | 25 | 25 |
| observations | | | |
| Number preferring | 9 | 11 | 10 |
| Control diet | | | |
| Number preferring | 16 | 14 | 15 |
| Test diet | | | |
| Number with no | 0 | 0 | 0 |
| preference | | | |
| Percent preferring | 36 | 44 | 40 |
| Control diet | | | |
| Percent preferring | 64 | 56 | 60 |
| Test diet | | | |
| Ave. total intake | 225.48 | 213.48 | 219.48 |
| Ave. intake of | 81.24 | 97.68 | 89.46 |
| control diet | | | |
| Ave. intake of Test | 144.24 | 115.8 | 130.02 |
| diet | | | |
| Intake ratio | 0.386 | 0.48 | 0.433 |
| Standard error | 0.045 | 0.0481 | 0.04655 |

While the present disclosure has been described with reference to embodiments, it will be understood by those skilled in the art that various modifications and variations may be made therein without departing from the scope of the present disclosure.

1. A pet food composition comprising steviol.

2. The pet food composition of claim 1, wherein the steviol is present in an amount of from 0.0007 weight % to 25 weight %, 0.0007 weight % to 20 weight %, 0.0007 weight % to 0.07 weight %, 0.003 weight % to 1 weight %, 0.003 weight % to 0.011 weight %, 0.005 weight % to 0.009 weight %, 0.001 weight % to 0.05 weight %, 0.007 weight % to 0.01 weight %, or about 0.007 weight %, based on a total weight of the pet food composition.

3. The pet food composition of claim 1, further comprising:
carbohydrates in an amount of from about 0 weight % to about 90 weight %;
protein in an amount of from about 5 weight % to about 70 weight %;
fat in an amount of from about 1 weight % to about 50 weight %;
dietary fiber in an amount of from about 0.1 weight % to about 40 weight %;
additives in an amount of from about 0 weight % to about 15 weight %, wherein the additives comprise vitamins and minerals, and antioxidants.

4. The pet food composition of claim 3, wherein:
the carbohydrates are present in an amount of from about 5 weight % to about 60 weight %;
the protein is present in an amount of from about 10 weight % to about 60 weight %
the fat is present in an amount of from about 2 weight % to about 40 weight %
the dietary fiber is present in an amount of from about 1 weight % to about 30 weight %; and
the additives are present in an amount of from about 2 weight % to about 8 weight %.

5. The pet food composition of claim 1, further comprising one or more of nonfermentable fiber, carnitine, chromium-picolinate, or combinations thereof.

6. The pet food composition of claim 1, wherein the pet food composition is a dry pet food composition.

7. The pet food composition of claim 1, wherein the pet food composition is a wet pet food composition.

8. The pet food composition of claim 1, further comprising a botanical.

9. The pet food composition of claim 8, wherein the botanical comprises one or more of cinnamon extract, green tea extract, or combinations thereof.

10. The pet food composition of claim 1, further comprising proanthocyanidins.

11. The pet food composition of claim 1, further comprising catechins.

12. The pet food composition of claim 1, wherein the pet food composition is a nutritionally complete diet.

13. A method for improving food intake of a pet comprising feeding the pet in need thereof the pet food composition of claim 1.

14. The method of claim 13, wherein the pet is a canine.

15. The method of claim 13, wherein the pet is a feline.

16. A method for manufacturing the pet food composition of claim 1, comprising:
mixing dry ingredients of the pet food composition;
combining the mixed dry ingredients with wet ingredients to provide a wet mixture;
extruding the wet mixture into kibble.
